(19) United States
(12) Patent Application Publication
(10) Pub. No.: US 2024/0019310 A1
(43) Pub. Date: Jan. 18, 2024

(54) METHOD AND SYSTEM FOR EXPANDING THE DYNAMIC RANGE OF MACH-ZEHNDER SENSOR BASED ON THE CALCULATION OF OPTICAL LENGTH

(71) Applicant: Shanghai Haina Data Technology Company Ltd., Shanghai (CN)

(72) Inventors: Rui YIN, Shanghai (CN); Qingjie HUANG, Shanghai (CN); Zhaoqi LI, Shanghai (CN)

(21) Appl. No.: 17/935,118

(22) Filed: Sep. 25, 2022

(30) Foreign Application Priority Data
Jul. 18, 2022 (CN) 202210840905.4

(51) Int. Cl. G01J 9/02

(52) U.S. Cl. CPC G01J 9/02; G01J 2009/0288

(57) ABSTRACT

A method and system are for expanding a measuring range of a Mach-Zehnder sensor based on the calculation of optical length; the method includes: (1) performing calibration according to a known parameter to complete calibration of a Mach-Zehnder pressure sensor; and (2) for an unknown parameter, testing the unknown parameter first using the Mach-Zehnder sensor to acquire discrete data; processing the discrete data using a peak and valley synthesis algorithm to restore a diffraction order m; calculating an optical length value of the unknown parameter; and restoring, according to a calibrated relationship curve between the optical length and the parameter, the unknown parameter, thus expanding the measuring range of the Mach-Zehnder sensor to enable the Mach-Zehnder sensor to break through the limitation of the FSR and the spectral width of a light source. The measuring range can be theoretically expanded to infinitely great.

### CROSS REFERENCES

This application claims priority to Chinese Patent Application Ser. No. CN202210840905.4 filed on 18 Jul. 2022.

### FIELD OF THE INVENTION

The present invention relates to a method and system for expanding a dynamic measuring range of a Mach-Zehnder sensor based on the calculation of optical length, and belongs to the technical field of optical measurement.

### BACKGROUND OF THE INVENTION

At present, in most methods for completing optical measurement by spectra, physical quantities to be measured are represented using single peak or valley value positions of the spectra. Many optical devices are based on the interference principle, and there is a free spectral range (FSR). A dynamic range of such a measuring instrument is limited by the FSR or a spectrum of a light source. The peak value does not have a one-to-one relationship with the physical quantity to be measured once it exceeds the FSR of the instrument. This is a common problem faced by current sensors based on spectral measurement.

To solve this problem, large dynamic range is usually achieved by reducing the sensitivity now. There are also the following problems: With the improvement of the sensor research level, the sensitivity of the sensor is also increasingly higher. Obviously, the measuring range of the sensor becomes smaller as the sensitivity increases. Therefore, in addition to the limitation to the FSR, the spectral width of a broad-spectrum light source is also limited. The spectral width of a common C-band ASE broad-spectrum light source is 40 nm to 70 nm. The spectral width of a visible light and near infrared light source will be slightly larger, but only 800 nm to 1000 nm. For many current sensors with ultra-high sensitivity, such as an ultra-high-sensitivity temperature sensor, the sensitivity reaches 50 nm/K or more, but the measuring range can only reach 20° C. even if a 1000 nm light source is used. This problem is unrelated to the FSR, and is a difficulty caused by the limited spectral line width of the broad-spectrum light source used in a test system.

Using nonlinear regression can increase the measuring range of a Mach-Zehnder sensor, but it needs to solve partial differential equations, which is difficult and inefficient.

Therefore, there is currently no simple and easy-to-operate solution for ultra-large ranges.

### SUMMARY OF THE INVENTION

For the shortcomings in the prior art, the present invention provides a method for expanding a measuring range of a Mach-Zehnder sensor based on the calculation of optical length. In the present invention, under the condition that the spectral width of a light source is greater than ½ of the FSR, the dynamic range of the sensor can be theoretically expanded beyond FSR. In this embodiment, massive computing like nonlinear regression is not required, so that requirements for a peripheral circuit are lowered, and the method is simple and easy to operate.

The present invention further provides a system for expanding the dynamic range of a Mach-Zehnder sensor based on the calculation of optical length.

### Explanation of Terms

FSR: It means Free Spectral Range. The FSR is a distance between two peak values (or valley values) of a transmission or reflection spectrum of an optical device.

The technical solutions of the present invention are as follows.

A method for expanding the dynamic range of a Mach-Zehnder sensor based on the calculation of optical length includes:
(1) making an asymmetric Mach-Zehnder sensor, the asymmetric Mach-Zehnder sensor including an input coupler, two sensing arms with different lengths, and an output coupler which are connected in sequence, an input end of the asymmetric Mach-Zehnder sensor being connected with a light source, and an output end of the Mach-Zehnder sensor being connected with an reading device (optical spectrum analyzer);
(2) for several known parameters, a Mach Zehnder sensor is used to obtain the discrete data; the discrete data is the optical power corresponding to different wavelengths; processing the discrete data using a peak and valley synthesis algorithm, and restoring a diffraction order m; calculating an optical length value of the known parameters to obtain a correction relationship curve between the optical length value and a measured parameter; and completing the calibration of the asymmetric Mach-Zehnder sensor; and
(3) for unknown parameters, testing the unknown parameters using the asymmetric Mach-Zehnder sensor to acquire discrete data; processing the discrete data using the peak and valley synthesis algorithm, and restoring a diffraction order m; calculating an optical length value of the unknown parameters; restoring the unknown parameters according to the calibrated relationship curve between the optical length and the parameter in step (2), thus expanding the measuring range of the asymmetric Mach-Zehnder sensor to enable the asymmetric Mach-Zehnder sensor to break through the limitation of the FSR of the instrument and the spectral width of the light source.

Preferably according to the present invention, in step (1), the spectral width of the light source selected by the asymmetric Mach-Zehnder sensor is greater than half of the FSR, so that the discrete data output by the asymmetric Mach-Zehnder sensor has at least one valley value and one peak value at the same time. It is convenient to use ratios of different peaks or valleys for subsequent calculation, so that the impact of process fluctuations on an arm difference ΔL of two arms of the Mach-Zehnder sensor is eliminated; and the reliability of calculation results is improved.

Preferably according to the present invention, in step (2) and step (3), the discrete data is processed using the peak and valley synthesis algorithm to restore the diffraction order m, specifically as follows:
as shown in FIG. 1, wavelengths corresponding to two adjacent peak values of the discrete data acquired by the asymmetric Mach-Zehnder sensor are λ₁ and λ₃, and the phase of the two arms is an even multiple of 2π, as shown in formulas (I) and (II):

$$2 m π = \frac{{2}_{π}}{{λ}_{1}} {n}_{{λ}_{1}} \cdot Δ L ( I ) , \qquad ( I )$$

$$2 ( m - 1 ) π = \frac{2 π}{{λ}_{3}} {n}_{{λ}_{3}} \cdot Δ L , \qquad ( II )$$

in formulas (I) and (II), m is the diffraction order; ΔL is the arm difference between the two arms of the Mach-Zehnder sensor; n_{λ1} is an effective refractive index of a waveguide corresponding to wavelength λ₁; n_{λ3} is an effective refractive index of a waveguide corresponding to wavelength λ₃;
a wavelength corresponding to a valley value between two adjacent peak values is λ₂; the phase of the two arms is an odd multiple of 2π, as shown in formula (III):

$$( 2 m - 1 ) π = \frac{2 π}{{λ}_{2}} {n}_{{λ}_{2}} \cdot Δ L , \qquad ( III )$$

in formula (III), n_{λ2} is an effective refractive index of a waveguide corresponding to wavelength λ₂.

Ideally, the effective refractive index of the waveguide may be calculated through a waveguide structure; ΔL is a design value; spectral data is measured; and the value of m can be calculated according to any one of formulas (I), (II), and (III). However, in actual situations, the effective refractive index of the waveguide and ΔL are uncertain due to the process fluctuations, in particular ΔL; when the waveguide bends, an optical field will be deviated from a center position of the waveguide (there is no accurate theory to calculate the deviation at present, and all existing methods are approximate processing methods), resulting in a lengthened path, thus affecting the value of ΔL; and as a result, the uncertain quantity of a product of n and ΔL is easily twice the wavelength or more.

Therefore, in this solution, the diffraction order m is calculated using the peak and valley synthesis algorithm, that is, using the ratios of different peak wavelengths or valley wavelengths, so that the impact of the process fluctuations on ΔL is eliminated; and the reliability of calculation results is improved. This method requires that the spectrum of the light source at least covers ½ of the FSR, that is, at least one peak value and valley value need to be acquired at the same time. In addition, it is required that there is only one polarization state.

When the acquired discrete data contains both a peak wavelength λ₂ and a valley wavelength Δ₁, and λ₁<λ₂:

$$( 2 m + 1 ) π = \frac{2 π}{{λ}_{1}} {n}_{{λ}_{1}} \cdot Δ L , \qquad ( IV )$$

$$2 m π = \frac{2 π}{{λ}_{2}} {n}_{{λ}_{2}} \cdot Δ L , \qquad ( V )$$

In formulas (IV) and (V), m is the diffraction order; ΔL is the arm difference between the two arms of the Mach-Zehnder sensor; n_{λ1} is an effective refractive index of a waveguide corresponding to wavelength λ₁; n_{λ2} is an effective refractive index of a waveguide corresponding to wavelength λ₂;
formula (IV) and formula (V) are divided:

$$\frac{{λ}_{1}}{{λ}_{2}} = \frac{{n}_{{λ}_{1}}}{{n}_{{λ}_{2}}} \cdot \frac{2 m}{2 m + 1} , \qquad ( VI )$$

Similarly, when the acquired discrete data contains both a peak wavelength λ₁ and a valley wavelength λ₂, and λ₁<λ₂:

$$\frac{{λ}_{1}}{{λ}_{2}} = \frac{{n}_{{λ}_{1}}}{{n}_{{λ}_{2}}} \cdot \frac{2 m - 1}{2 m} . \qquad ( VII )$$

Formulas (VI) and (VII) are the core principles for calculating the diffraction order on the basis of peaks and valleys provided by the present invention, where λ₁ and λ₂ are acquired and measured by the optical measuring device in step (2). There are mature empirical formulas for relationships between the refractive indexes and wavelengths of commonly used optical waveguide materials (Si, SiO₂, LiNbO₃, and the like); variations of the effective refractive indexes of the waveguides can be approximately considered to be equal to changes of the refractive indexes of the materials. Since the refractive indexes of two wavelengths are on the denominator and the numerator respectively, and the process fluctuations have the same impact on the refractive indexes at different wavelengths, formula (VI) can also greatly offset the fluctuations of the refractive indexes by the process.

Adjacent peak wavelengths and valley wavelengths in the discrete data, as well as n_{λ1} and n_{λ2} are substituted into formula (VI) or formula (VII), thus obtaining the diffraction order m.

Preferably according to the present invention, in step (2) and step (3), the specific process of calculating the optical length value of the known parameters or the unknown parameters is as follows: first performing translation and scaling transformation on the discrete data such that the amplitude of the discrete data is ±1; and taking an arc-cosine function to obtain a phase value; and superimposing am to obtain a total optical length value.

The method provided by the present invention is extremely high in fault tolerance, which is proved as follows:

Error E is recorded as:

$$E ( m ) = \{ \begin{matrix}\frac{λ 1}{λ 2} - \frac{n λ 1}{n λ 2} \cdot \frac{2 m}{2 m + 1} , when λ 1 is valley \\ \frac{{λ}_{1}}{{λ}_{2}} - \frac{n {λ}_{1}}{n {λ}_{2}} \cdot \frac{2 m - 1}{2 m} , when λ 1 is peak\end{matrix} \qquad ( VIII )$$

FIG. 2 shows a theoretical calculation result of a sensor based on a Mach-Zehnder structure near m=32. When the data of the wavelength or refractive index is deviated, error E will occur. If there is an error in a certain parameter that causes E(32) to increase, E(31) and E(33) will also increase. When E(33) is closer to 0, m is determined as 33, which is a misjudgment. Specifically, m in FIG. 2 should be 32, but when error E(32)>Eₘₐₓ, the error at m=33 will be less than Eₘₐₓ, resulting in the misjudgment of m; and similarly, when E(32)<−Eₘₐₓ, a misjudgment will also occur. Therefore, ±Eₘₐₓ is an upper error limit to ensure that the method runs normally.

A lithium niobate asymmetric Mach-Zehnder structure is taken as an example. The effective refractive index of the waveguide of the structure is about 2.17; the arm difference is 21.73 μm; and the light source uses a C-band ASE broad-spectrum light source:
(1) The impact of a measuring error of the peak wavelength and the valley wavelength on E: as shown in FIG. 3, it can be seen that the wavelength tolerance of this method is about ±0.35 nm. Considering that the resolution of a spectrometer is generally 0.02 nm, so the requirements for wavelength measurements can be quite low.
(2) The impact of the value of n1.55 on E: during the calibration in step (2), if the physical quantity to be measured is known, the effective refractive index of the waveguide only changes with the wavelength. Usually, the width of the light source is several tens of nanometers. Since linear approximation is performed in this relatively small range, the error is relatively small. Therefore, it is defined:

n_{eff}=n_{1.55}+dₙ·(λ−1.55) (IX)

In formula (IX), n_{1.55} is the effective refractive index of the waveguide at 1550 nm, and dₙ is a wavelength-varying coefficient of the effective refractive index of the waveguide. FIG. 4 shows the impact of the value of n_{1.55} on E. It can be seen that an allowable range is between 1.3 and 3.6. The range of 1.3-3.6 has covered most of media in nature. That is, the effective refractive index of the waveguide can be any value between 1.3 and 3.6. In addition, the effective refractive index of the waveguide is between the refractive index of a cladding layer and the refractive index of a core layer. It is usually difficult to determine the precise value of the effective refractive index because the process fluctuations make the size and material components of the waveguide change. However, for this method, either the refractive index of the core layer or the refractive index of the cladding layer can be used as the effective refractive index of the waveguide, which is in the allowable range. Therefore, it can be said that this method has no precision requirement for the effective refractive index.
(3) The impact of the value of dₙ on E: as shown in FIG. 5, it can be seen from FIG. 5 that the value of do is still relatively wide, about 0.012-0.054 RIU/μm. This parameter of lithium niobate is about −0.03 near 1550 nm, and the impact of the waveguide structure and process on this parameter will not exceed 0.01. Therefore, this method still has super-high fault tolerance in this respect.

As a comparative example, if only formula (I) is used to calculate m without using peaks and valleys, and if exact values are: n_{1.55}=2.22, wavelength=1550 nm and arm difference=22.34 microns, m=32. It is assumed that the refractive index has an error of 0.01; the wavelength has no error; and the arm difference has an error of 0.3 microns (which is a standard tolerance of contact lithography). In this way, calculated m=32.5758; and if m exceeds 32.5, it will be determined that m=33, which is a calculation failure. A larger m indicates larger ΔL. If formula (I) is used for calculation, the requirement for the tolerance of ΔL is higher. At this time, the advantage of this method is more obvious. In addition, m of a general integrated optical waveguide device is about 30-200.

However, if the method provided by the present invention is adopted, E is 0.0001467 under the same conditions. Eₘₐₓ of 0.00023 is 64% of a misjudgment threshold, and there is still a margin. The main reason is that this method eliminates the impact of ΔL, and puts the remaining similar parameters on the numerator and denominator at the same time, which can offset the fluctuations of various numerical values to an extremely large extent, so the fault tolerance is quite good.

To sum up, the method has high operability and can accurately restore the current diffraction order of the Mach-Zehnder sensor. With the diffraction order, the physical quantity to be measured can be calculated. This method is not limited by the FSR, and can achieve measurement as long as the sensor is not damaged under measuring conditions such as high temperature or high pressure.

An implementation system for expanding a measuring range of a Mach-Zehnder sensor based on the calculation of optical length includes a light source, an asymmetric Mach-Zehnder sensor, a discrete data acquisition module, an optical length calculation module, and a physical-quantity-to-be-measured calculation module which are connected in sequence.

The discrete data acquisition module includes an optical measuring device, used for measuring acquired discrete data; and the optical measuring device includes a spectrometer or an optical power meter.

The optical length calculation module is used for processing the discrete data using a peak and valley synthesis algorithm, restoring a diffraction order m, and calculating an optical length value of parameters.

The physical-quantity-to-be-measured calculation module is used for restoring unknown parameters according to a calibrated relationship curve between the optical length value and the parameter, thus calculating a physical quantity to be measured.

The present invention has the beneficial effects below.
1. The existing ultra-high-sensitivity optical sensors on the market cannot expand the range infinitely. In the present invention, during optical measurement, the measuring range of the Mach-Zehnder sensor can be expanded to be theoretically infinite only by optical length calculation, without increasing the spectral width of the light source, and the measuring range is actually only limited by a normal interference range of the sensor, instead of the FSR and the spectral width of the light source.
2. In the present invention, the peak and valley synthesis algorithm is adopted, that is, the diffraction order m is calculated using the radios of different peak wavelengths or valley wavelengths. This method has relatively high fault tolerance and high operability, and can accurately restore the current diffraction order of the Mach-Zehnder sensor, thus calculating the physical quantity to be measured. This method is not limited by the FSR, and can achieve measurement as long as the sensor is not damaged under measuring conditions such as high temperature or high pressure.

### BRIEF DESCRIPTION OF THE DRAWINGS

FIG. 1 is an output spectral image of an asymmetric Mach-Zehnder sensor;

FIG. 2 is a definition diagram of error E;

FIG. 3 is a schematic diagram of the impact of fluctuations of peaks or valleys on error E;

FIG. 4 is a schematic diagram of the impact of fluctuations of the effective refractive index of a waveguide at a wavelength of 1550 nm on error E;

FIG. 5 is a schematic diagram of the impact of fluctuations of a wavelength-varying coefficient dₙ of the refractive index of a material on error E;

FIG. 6 is a schematic structural diagram of an asymmetric Mach-Zehnder sensor based on a lithium niobate waveguide provided in Embodiment 1;

FIG. 7 is discrete data of the Mach-Zehnder sensor acquired by an optical measuring device in Embodiment 1;

FIG. 8 is a schematic diagram of the impact of errors at various diffraction orders m on error E; and

FIG. 9 is comparison between final test results of the asymmetric Mach-Zehnder sensor in Embodiment 1 and theoretical results.

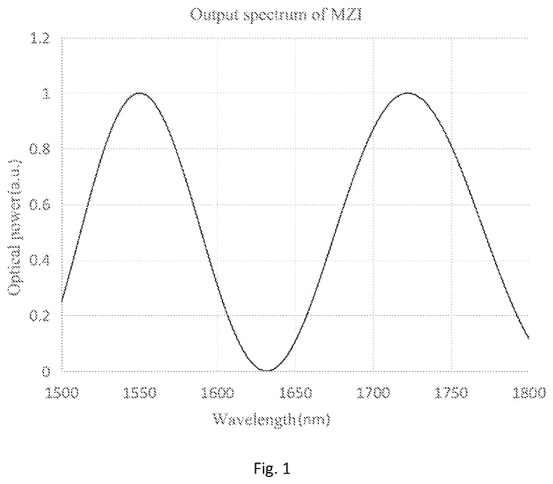

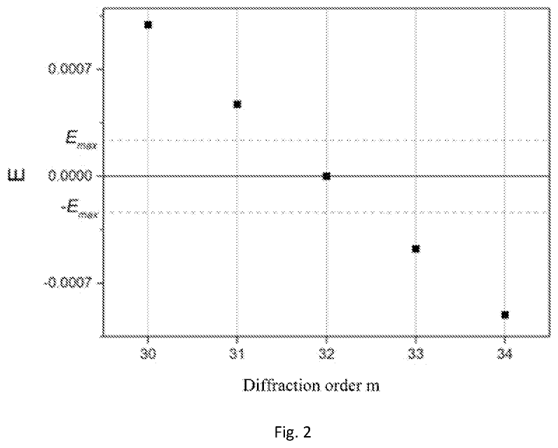

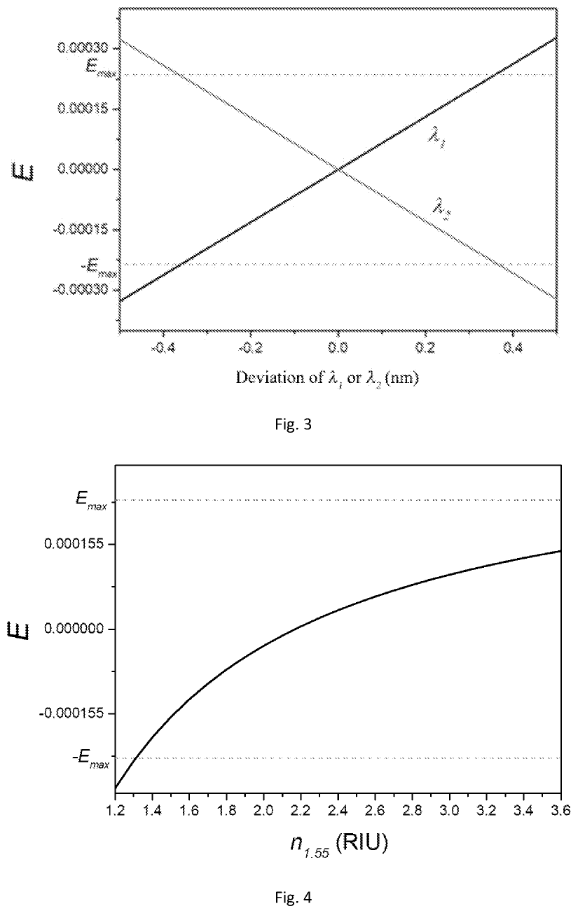

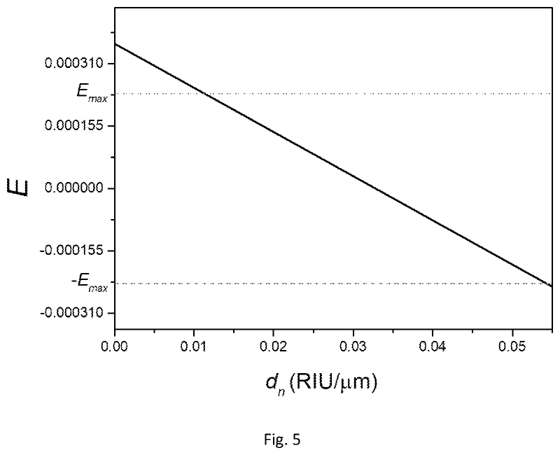

### DETAILED DESCRIPTION OF THE EMBODIMENTS

The present invention is further described below in combination with the embodiments and the drawings of the specification, but is not limited to this.

### Embodiment 1

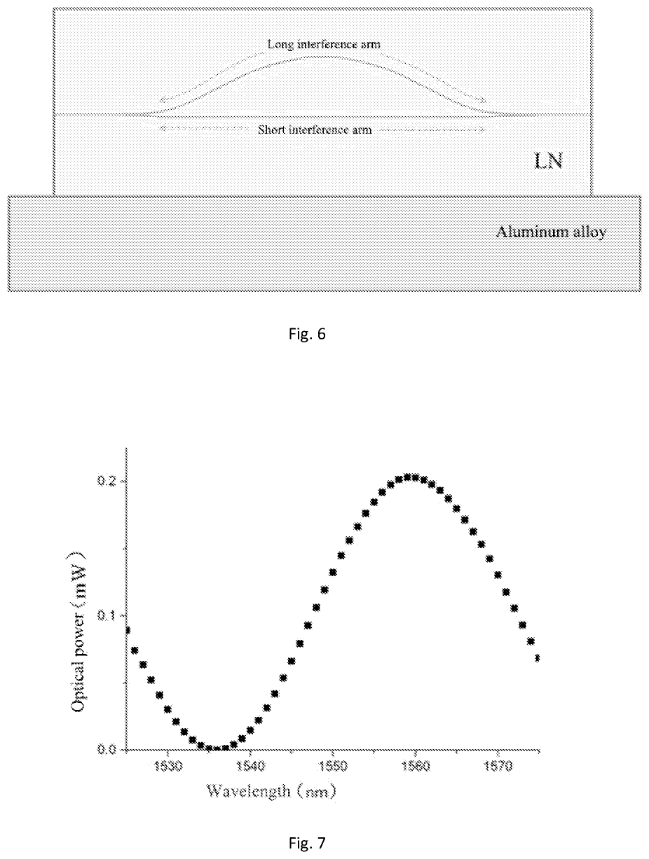

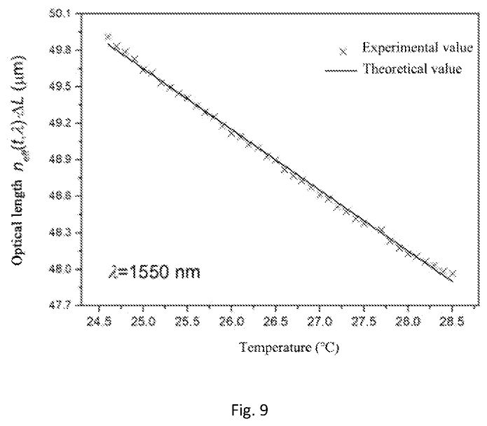

A method for expanding a measuring range of a Mach-Zehnder temperature sensor based on the calculation of optical length includes the following steps:
(1) An asymmetric Mach-Zehnder temperature sensor based on a lithium niobate waveguide is manufactured; the asymmetric Mach-Zehnder sensor is bonded to an aluminum alloy; and a phase difference between two arms in the asymmetric Mach-Zehnder sensor is changed using a stress caused by a temperature. The structure of the sensor is as shown in FIG. 6. The waveguide structure is made by a proton exchange process, which ensures that there is only one polarization state and improves the measuring accuracy. The asymmetric Mach-Zehnder sensor includes an input coupler, two sensing arms with different lengths, and an output coupler, which are connected in sequence; an input end of the asymmetric Mach-Zehnder sensor is connected with a light source; and an output end of the Mach-Zehnder sensor is connected with an optical measuring device.
(2) The asymmetric Mach-Zehnder sensor is first used to test known parameters to acquire discrete data. The discrete data is the optical power corresponding to different wavelengths. The obtained discrete data is as shown in FIG. 7, and the discrete data includes the optical power corresponding to different wavelengths. The discrete data is processed using a peak and valley synthesis algorithm to restore a diffraction order m; an optical length value of the known parameters is calculated, thus obtaining a correction relationship curve between an optical length and the measured parameters. In this embodiment, the measured parameter is temperature, and a temperature-varying coefficient dₜ of the obtained optical length is corrected; and the calibration of the asymmetric Mach-Zehnder sensor is completed. The relationship curve between the optical length and the measured parameter is as shown in FIG. 9, in which the solid line represents a theoretical calculation result, and the other line represents a calibrated result.

As shown in FIG. 7, the valley wavelength is λ₁=1535.915 nm, and the peak wavelength is λ₂=1559.432 nm. When the wavelength is 1550 nm, the effective refractive index of the lithium niobate waveguide is 2.17, and the wavelength-varying coefficient of the effective refractive index is dₙ=0.031. In this embodiment, the parameter tested by the Mach-Zehnder sensor is temperature. The arm difference of the Mach-Zehnder structure is different due to different structural deformations at different temperatures. Mathematically, the arm difference is considered to be the same, and the length of an actual change of the arm difference is converted into the change of the refractive index, so that it is relatively simple during processing. At this time, the calculation formula of the effective refractive index of the lithium niobate waveguide along with wavelength and temperature is n_{λ}=n_{1.55}+dₙ·(λ−1.55)+dₜ·(t−t₀) (X), where t₀ is an initial temperature, and dₜ is a temperature-varying coefficient of the effective refractive index. Therefore, from which n_{λ1} and n_{λ2} can be calculated.

When the temperature is 26.5° C., the peak wavelength of the discrete data is λ₁=1528.3 nm, and the valley wavelength is λ₂=1552.4 nm; when the temperature is 28.6° C., the peak wavelength of the discrete data is λ₁=1545.9 nm, and the valley wavelength is λ₂=1570.6 nm; and n_{λ1} and n_{λ2} are calculated according to formula (X). λ₂=1552.4 nm and λ₂=1570.6 nm, as well as n_{λ1} and n_{λ2}, are brought into

$$\frac{{λ}_{1}}{{λ}_{2}} = \frac{{n}_{{λ}_{1}}}{{n}_{{λ}_{2}}} \cdot \frac{2 m}{2 m + 1} . \qquad ( VI )$$

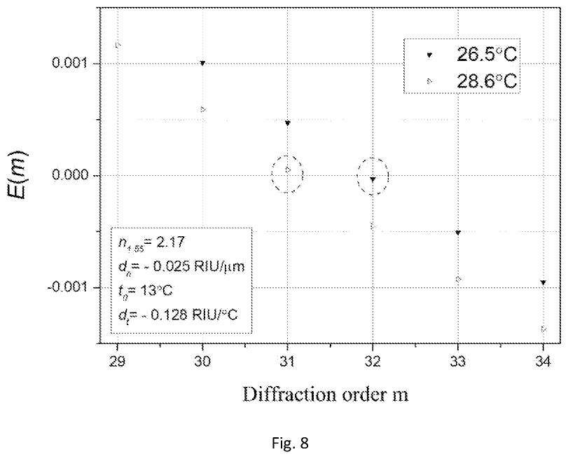

After optimization, when n_{1.55}=2.17, dₙ=−0.025 RIU/μm, 13° C., and dₜ=−0.128 RIU/° C., the errors at the various diffraction orders m are as shown in FIG. 8. Since this is a calibration process, it is known that a difference between the diffraction orders m at two temperatures is 1, which belongs to a reasonable determining range. From this, it can be determined that n_{1.55}=2.17, dₙ=−0.025 RIU/μm, t₀=13° C., and dₜ=−0.128 RIU/° C.

The optical length value of the known parameters is calculated according to the diffraction order m, and then the correction relationship curve between the optical length value and the measured parameter is obtained, thus completing the calibration of the asymmetric Mach-Zehnder sensor.

(3) Measurement is performed. Temperature t is unknown at this time. For an unknown parameter, i.e. temperature t, discrete data is acquired first using the asymmetric Mach-Zehnder sensor; the discrete data is processed using the peak and valley synthesis algorithm according to relevant parameters of the effective refractive index obtained in step (2), so as to restore a diffraction order m; and an optical length value of the unknown parameter is calculated to restore the unknown parameter, i.e. temperature t.

In this embodiment, in step (2), a measuring curve can be obtained by calibrating 26.5° C. and 28.6° C.

In step (3), m is first determined through the spectrum of the unknown temperature; the optical length is then calculated; and the correction measuring curve obtained in step (2) is queried, thus obtaining the temperature value.

In this embodiment, the sensitivity of the sensor is about 16 nm/° C., and the spectral width of the light source is 50 nm. If the temperature is determined according to the traditional method and a peak position, the measuring range is only 50/16=3.125° C. However, by using the method provided in the present invention, the measuring range can exceed this limit. In this embodiment, only the measuring range of 4° C. is shown. It is unnecessary to describe a larger measuring range.

### Embodiment 2

A method for expanding a measuring range of a Mach-Zehnder pressure sensor based on the calculation of optical length is different from Embodiment 1 in that:
(1) A high-sensitivity pressure sensor based on an asymmetric Mach-Zehnder interference principle.
(2) Calibration is performed according to a known pressure to obtain an optical length value at the known measured parameter, so that a correction relationship curve between the optical length and the measured parameter, i.e. the pressure, is obtained, thus completing the calibration of the Mach-Zehnder pressure sensor.
(3) According to the calibrated value of dₙ, for an unknown pressure, the value of m is determined; the spectrum is moved and stretched to plus and minus 1; an arc-cosine function is used to obtain a phase value which is superimposed with am to obtain a total optical length value; and the total optical length value is compared with the calibrated value to restore a measured pressure value.

### Embodiment 3

A method for expanding a measuring range of a Mach-Zehnder refractive index sensor based on the calculation of optical length is different from Embodiment 1 in that:
(1) A high-sensitivity refractive index sensor based on an asymmetric Mach-Zehnder interference principle.
(2) Calibration is performed according to a known liquid or gas refractive index to obtain an optical length value at the known measured parameter, so that a correction relationship curve between the optical length and the measured parameter, i.e. liquid or gas, is obtained, thus completing the calibration of the Mach-Zehnder pressure sensor.
(3) According to the calibrated value of dₙ, for an unknown liquid or gas refractive index, the value of m is determined; the spectrum is moved and stretched to plus and minus 1; an arc-cosine function is used to obtain a phase value which is superimposed with 2πm to obtain a total optical length value; and the total optical length value is compared with the calibrated value to restore a measured refractive index.

### Embodiment 4

A system for expanding a measuring range of a Mach-Zehnder sensor based on the calculation of optical length is used for implementing the method for expanding the measuring range of the Mach-Zehnder sensor based on the the calculation of optical length provided in any one of Embodiments 1-3, and includes a light source, an asymmetric Mach-Zehnder sensor, a discrete data acquisition module, an optical length acquisition module, and a physical-quantity-to-be-measured acquisition module which are connected in sequence.

The discrete data acquisition module includes an optical measuring device, used for measuring acquired discrete data; and the optical measuring device includes a spectrometer or an optical power meter.

The optical length calculation module is used for processing the discrete data using a peak and valley synthesis algorithm, restoring a diffraction order m, and calculating an optical length value of parameters.

The physical-quantity-to-be-measured calculation module is used for restoring unknown parameters according to a calibrated relationship curve between the optical length value and the parameter, thus calculating a physical quantity to be measured.

What is claimed is:

1. A method for expanding a measuring range of a Mach-Zehnder sensor based on the calculation of optical length, comprising:
(1) making an asymmetric Mach-Zehnder sensor, an input end of the asymmetric Mach-Zehnder sensor being connected with a light source, and an output end of the Mach-Zehnder sensor being connected with an optical measuring device;
(2) for several known parameters, testing the known parameters first using the asymmetric Mach-Zehnder sensor to acquire discrete data, the discrete data being optical power corresponding to different wavelengths; processing the discrete data using a peak and valley synthesis algorithm, and restoring a diffraction order m; calculating an optical length value of the known parameters to obtain a correction relationship curve between the optical length value and a measured parameter; and completing the calibration of the asymmetric Mach-Zehnder sensor; and
(3) for unknown parameters, testing the unknown parameters using the asymmetric Mach-Zehnder sensor to acquire discrete data; processing the discrete data using the peak and valley synthesis algorithm, and restoring a diffraction order m; calculating an optical length value of the unknown parameters; restoring the unknown parameters according to the calibrated relationship curve between the optical length and the parameter in step (2), thus expanding the measuring range of the asymmetric Mach-Zehnder sensor to enable the asymmetric Mach-Zehnder sensor to break through the limitation of the FSR of the instrument and the spectral width of the light source.

2. The method for expanding the measuring range of the Mach-Zehnder sensor based on the calculation of optical length according to claim 1, wherein in step (1), the spectral width of the light source selected by the asymmetric Mach-Zehnder sensor is greater than half of the FSR, so that the discrete data output by the asymmetric Mach-Zehnder sensor has at least one valley value and one peak value at the same time.

3. The method for expanding the measuring range of the Mach-Zehnder sensor based on the calculation of optical length according to claim 1, wherein in step (2) and step (3), the discrete data is processed using the peak and valley synthesis algorithm to restore the diffraction order m, specifically as follows: the diffraction order m is calculated using the peak and valley synthesis algorithm, that is, using ratios of different peak wavelengths or valley wavelengths; when the acquired discrete data simultaneously contains one peak wavelength λ₂ and one valley wavelength λ₁, and λ₁<λ₂:
$$\frac{{λ}_{1}}{{λ}_{2}} = \frac{{n}_{{λ}_{1}}}{{n}_{{λ}_{2}}} \cdot \frac{2 m}{2 m + 1} , \qquad ( VI )$$
when the acquired discrete data contains both a peak wavelength λ₁ and a valley wavelength λ₂, and λ₁<λ₂:
$$\frac{{λ}_{1}}{{λ}_{2}} = \frac{{n}_{{λ}_{1}}}{{n}_{{λ}_{2}}} \cdot \frac{2 m - 1}{2 m} , \qquad ( VII )$$
in formulas (VI) and (VII), m is the diffraction order; n_{λ1} is the effective refractive index of a waveguide corresponding to wavelength λ₁; n_{λ2} is the effective refractive index of a waveguide corresponding to wavelength λ₂; λ₁ and λ₂ are measured by the optical measuring device; n_{λ1} and n_{λ2} are obtained according to the empirical formula;
adjacent peak wavelengths and valley wavelengths in the discrete data, as well as n_{λ1} and n_{λ2} are substituted into formula (VI) or formula (VII), thus obtaining the diffraction order m.

4. The method for expanding the measuring range of the Mach-Zehnder sensor based on the calculation of optical length according to claim 1, wherein in step (2) and step (3), the specific process of calculating the optical length value of the known parameters or the unknown parameters is as follows: first performing translation and scaling transformation on the discrete data such that the amplitude of the discrete data is ±1; and calculating an arc-cosine function to obtain a phase value; and superimposing 2πm to obtain a total optical length value.

5. An implementation system for expanding a measuring range of a Mach-Zehnder sensor based on the calculation of optical length, which is used for implementing the method for expanding the measuring range of the Mach-Zehnder sensor based on the calculation of optical length according to claim 1, wherein the system comprises a light source, an asymmetric Mach-Zehnder sensor, a discrete data acquisition module, an optical length acquisition module, and a physical-quantity-to-be-measured acquisition module which are connected in sequence;
the discrete data acquisition module comprises an optical measuring device, used for measuring acquired discrete data;
the optical length calculation module is used for processing the discrete data using a peak and valley synthesis algorithm, restoring a diffraction order m, and calculating an optical length value of parameters; and
the physical-quantity-to-be-measured calculation module is used for restoring unknown parameters according to a calibrated relationship curve between the optical length value and the parameter, thus calculating a physical quantity to be measured.
